(19) United States
(12) Patent Application Publication
(10) Pub. No.: US 2008/0148222 A1
(43) Pub. Date: Jun. 19, 2008

(54) PROGRAMMABLE AUTOMATIC TRIGGERING SYSTEM AND APPARATUS

(75) Inventor: Yi-Ming Pao, Hsichih City, Taipei Hsien (TW)

Correspondence Address: MOXA TECHNOLOGIES CO., LTD, P.O. BOX 108-00403, TAIPEI, omitted

(73) Assignee: MOXA TECHNOLOGIES CO., LTD., Shing Tien City (TW)

(21) Appl. No.: 11/613,172

(22) Filed: Dec. 19, 2006

(51) Int. Cl. G06F 9/44

(52) U.S. Cl. 717/106

(57) ABSTRACT

Programmable automatic triggering system and apparatus include a programmable automatic triggering system and automatic triggering apparatus. The programmable automatic triggering system includes a menu display module and a program code generating module. The menu display module has one or more menu control instructions and each menu control instruction corresponds to an output menu control instruction. The program code generating module of the programmable automatic triggering system compiles menu control instructions set by a user into machine readable program codes, and a real-time processor of the automatic triggering apparatus processes the program codes generated by the program code generating module and controls or instructs a preinstalled input/output device connected to the automatic triggering apparatus, so that the user can set up the programmable automatic triggering system easily.

### BACKGROUND OF THE INVENTION

1. Field of the Invention

The present invention relates to a system and an apparatus that allow users to set a menu control instruction by a menu display module or a program code, so that users no longer need to learn the difficult syntax of a program to complete a complicated setup for automated controls.

2. Description of Related Art

In present society and system, economic benefit and cost-effectiveness are emphasized, and all industries including the light industry, the heavy industry and service industry have common objectives of reducing manpower and improving productivity, and thus automated productions or automated processes become one of the effective feasible solutions for reducing the manpower, improving the operating safety and economic effectiveness. For instance, a general manufacturing industry adopts a large number of automated equipments for the production line to improve product quality and lower costs, and the automated equipments can be operated in poor working environments such as a paint spray room, a working room operated at abnormal temperatures or any environment not suitable for people to work for long hours. Further, these automated equipments can work for us for a long time, if the equipments are maintained appropriately.

Although the automated equipments have the aforementioned advantages, it is not easy to maintain the operation of these automated equipments to a quality level up to our expectation. Therefore, it is very important to control automated equipments properly, and the precision of controlling automated equipments plays an important role in product quality. For existing control components, a personal computer is generally used for controlling a programmable logic controller to send an instruction or a program to the automated equipment, so that the automated equipment can be operated according to the instruction. However, the aforementioned programmable logic controller cannot be operated independently or solely, but is operated with a synchronized personal computer. Therefore, users have need to reserve a place for installing the personal computer in order to use the automated equipments, and users also need to connect and install wires and cables, and thus incurring an additional cost.

The programmable logic controller available in the market has become a mainstream, and users can input an editing program instruction in a memory module of the programmable logic controller, such that the programmable logic controller can generate corresponding control logic to control external output devices. In general, a command of the programmable logic controller requires initial values, system parameters and interrupts to set related input and output switches. Unless users are familiar with the related program instructions, users need to check program instructions and their operations one by one in a user's guide d to code a program. Beginners usually end up with a missing instruction or a programming error that may cause tremendous problems to the operation of the output devices.

In view of the shortcomings of the prior art, it is a subject for manufacturers of the related industry to find feasible ways of simplifying the setup of a programmable logic controller, lowering chance of making a programming error, improving the accuracy and reliability of editing a program, cutting down the development cost of existing systems, and designing an independent programmable logic controller.

### SUMMARY OF THE INVENTION

Therefore, it is a primary objective of the present invention to use a menu display module to set a menu control instruction, so that users can set corresponding menu control instructions without the need of learning the difficult syntax of the program. Users can set up a programmable automatic triggering system in a simple and easy manner, so that errors occurred in the programming editing and setup procedure can be reduced significantly, and the manufacturer's acceptance can be enhanced effectively.

The secondary objective of the present invention is to maintain a good communication between the automation and its users through the exchange of messages or communication with the automatic triggering apparatus via mail, SNMP or active messaging, if an external input/output device is connected to the automatic triggering apparatus and specific conditions are satisfied.

### BRIEF DESCRIPTION OF THE DRAWINGS

FIG. 1 is a block diagram of a preferred embodiment of the present invention.

FIG. 2 is a flow chart of setting a programmable automatic triggering system of the present invention.

FIG. 3 is a schematic view of setting a digital input/output operating interface of the present invention.

FIG. 4 is a schematic view of managing an operating interface of a menu control instruction of the present invention.

FIG. 5 is a schematic view of an operating interface of a menu display module and a program instruction display module of the present invention.

### DETAILED DESCRIPTION OF THE PREFERRED EMBODIMENTS

To achieve the foregoing objectives and effects, the objectives, structure, innovative features, and performance of the present invention will be apparent in the following detailed description of the preferred embodiments with reference to the accompanying drawings.

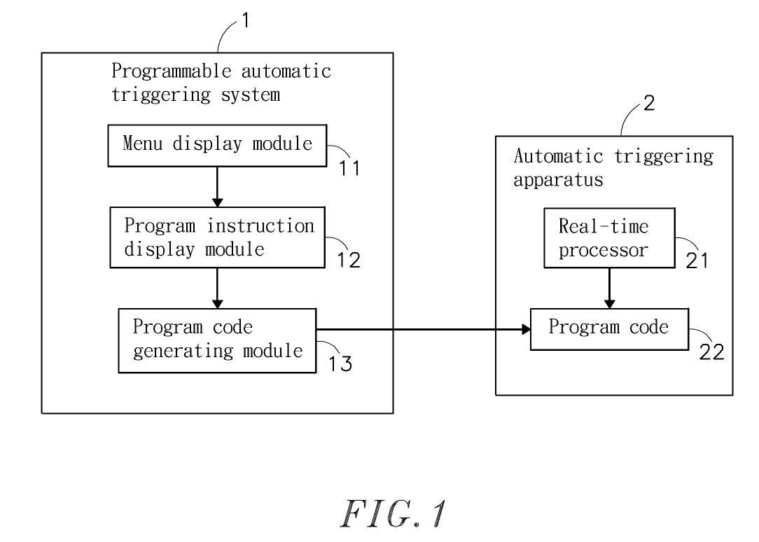

Referring to FIG. 1 for a block diagram of a preferred embodiment of the present invention, the programmable automatic triggering system and apparatus comprise a programmable automatic triggering system 1 and an automatic triggering apparatus 2, and the main characteristics of such system and apparatus will be described as follows.

The programmable automatic triggering system 1 includes a menu display module 11, a program instruction display module 12 and a program code generating module 13. The menu display module 11 includes one or more menu control instructions, and each menu control instruction has a corresponding digital output menu control instruction provided for users to sequentially select the corresponding menu control instruction. The program instruction display module 12 is provided for displaying a menu control instruction selected by the menu display module 11 and expressed in a human like logic, so that users can determine and confirm the accuracy of setting the menu control instruction. Further, the program code generating module 13 compiles the menu control instruction that is set by users and converts the menu control instruction into a machine readable program code.

The automatic triggering apparatus 2 includes a real-time processor 21 and a program code 22, and the real-time processor 21 produces a program code 22 from the program code generating module 13 for the computation and controls a preinstalled input/output device that is connected to the automatic triggering apparatus 2.

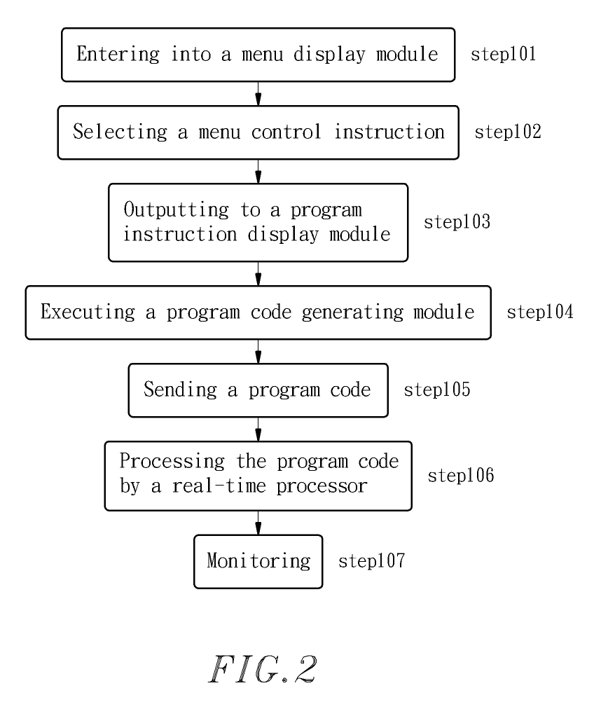

Referring to FIG. 2 for a flow chart of setting a programmable automatic triggering system in accordance with the present invention, the programmable automatic triggering system is set up by a procedure comprises the following steps.

In Step 101, this step enters into a menu display module 11 of a programmable automatic triggering system 1, and then Step 102 is carried out.

In Step 102, a user selects a menu control instruction, and a corresponding output menu control instruction, and then Step 103 is carried out.

In Step 103, the programmable automatic triggering system 1 converts the menu control instruction that is selected by the user into a human-like logic, and outputs the human-like logic to a program instruction display module 12.

In Step 104, the program code generating module 13 compiles the menu control instruction that is set by the user into a machine readable program code, and then Step 105 is carried out.

In Step 105, the programmable automatic triggering system 1 sends a program code 22 that is compiled by the program code generating module 13 to an automatic triggering apparatus 2, and then Step 106 is carried out.

In Step 106, a real-time processor 21 of the automatic triggering apparatus 2 processes the program code 22, and then Step 107 is carried out.

In Step 107, the automatic triggering apparatus 2 monitors and controls the digital input and output of the device, and then the procedure is ended.

In Steps 105 and 106 for setting the programmable automatic triggering system, the automatic triggering apparatus 2 can be interacted independently with an external input/output device without the need of synchronously connecting to a server, after the program code generating module 13 sends the compiled program code 22 to the automatic triggering apparatus 2.

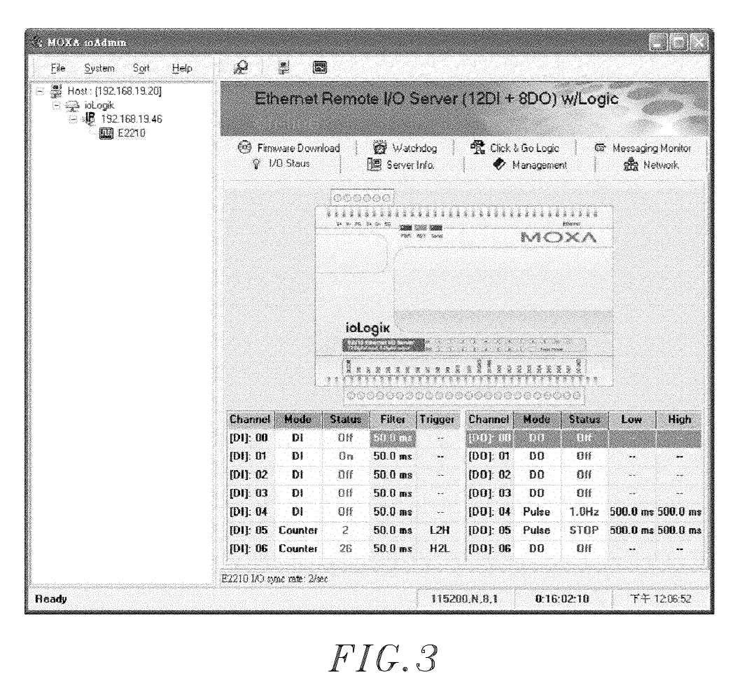

Referring to FIG. 3 for a schematic view of setting a digital input/output operating interface, a user can operate at different modes and set different statuses based on different digital input/output channels of the automatic triggering apparatus 2.

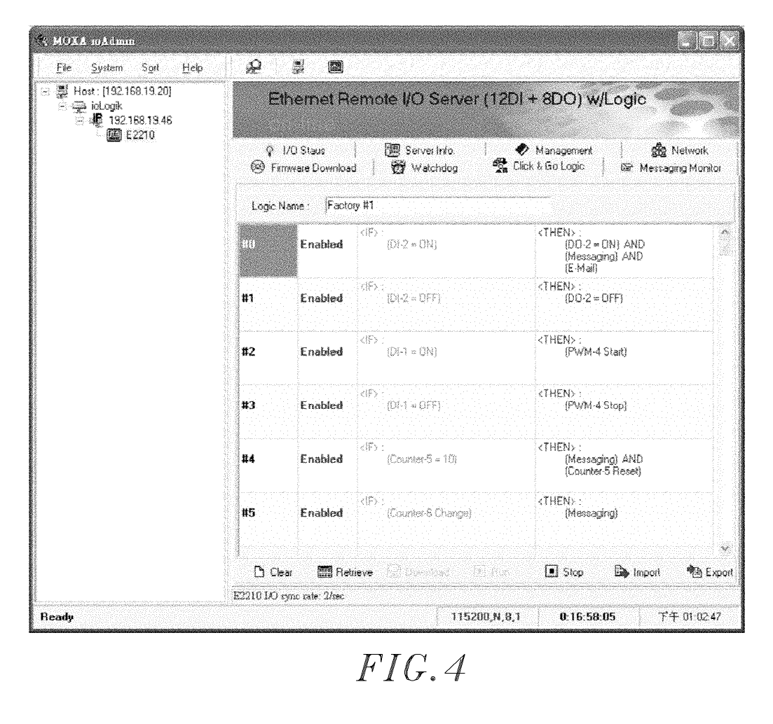

Referring to FIG. 4 for a schematic view of managing an operating interface of a menu control instruction of the present invention, a user can use the operating interface to carry out the management instruction such as clear, intercept, download, import and export a menu control instruction according to different conditions, and check the menu control instructions for different conditions.

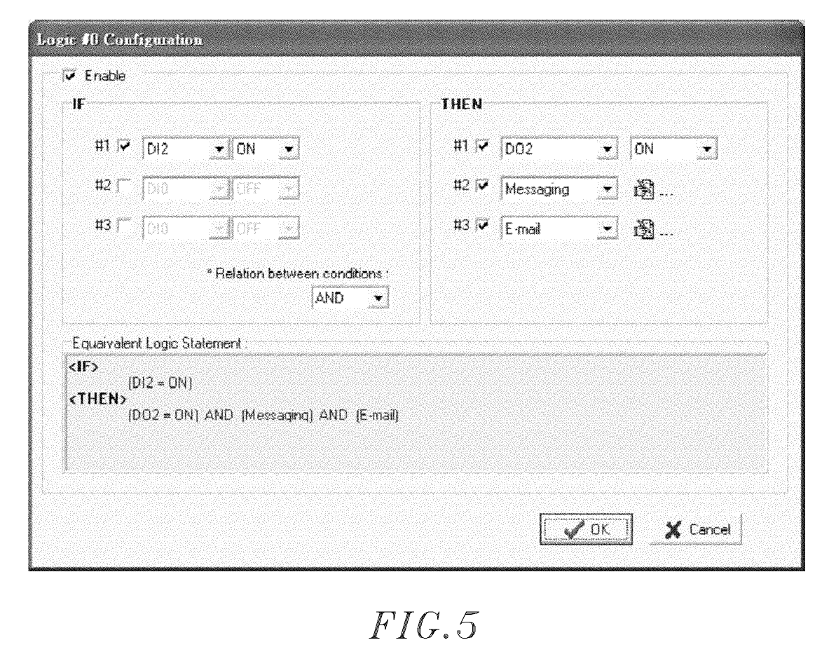

Referring to FIGS. 1 and 5 for schematic views of an operating interface of a menu display module 11 and a program instruction display module 12, a user can select one or more menu control instructions. Similarly, the user can select an output menu control instruction corresponding to the input menu control instruction. After the foregoing menu control instruction is set, the program instruction display module 12 will determine and display the syntax of the human-like menu control instruction, such that the user can edit and read the menu control instruction.

The core technology of the present invention applied in a traditional building automated system is illustrated here. A general building adopts the concept of using a plurality of remote input/output devices for the design of the building, and all events and responses are controlled by a computer in an engine room through a transmission interface. If there is any usual situation or emergency, the personnel or computer in the engine room will issue an instruction to the external input/output device to execute a certain operation, such as turning on a heat dissipating fan if the temperature is too high, lighting up a warning lamp if the safety door is opened abnormally, or starting an automatic sprinkler system if the temperature exceeds a predetermined fire protection temperature. Since all these are urgent operations, we can reduce the chance of accidents and minimize the loss, if related measures and operations can be started timely. Therefore, a user may connect a micro switch to a digital input of an input/output device at a remote end and install the micro switch on a desired monitoring and controlling door and connect a buzzer to a digital output of the input/output device at the remote end, such that if the door is opened, the buzzer will be triggered and a series of operations will be completed within a few milliseconds, so as to give a quick response. Besides the surveillance for the door security, the temperature and humidity also can be monitored and controlled by the programmable automatic triggering system of the present invention.

Therefore, the aforementioned input/output menu control instruction mode can be used as a trigger condition for turning on/off a power supply or computing the numeric value of a counter or timer.

Further, the corresponding operation of the input/output menu control instruction can be a control of turning on/off or pausing the power supply of an input/output device, or an exchange of messages or a communication via mail, SNMP or active messaging. The foregoing programmable automatic triggering system can be used in a desktop computer, a portable computer, an industrial computer, a server, a personal digital assistant or any device with computing and storing functions.

In summation of the description above, the present invention have the following advantages over the prior art.

(1) The present invention adopts a menu control instruction of the menu display module 11 and an output menu control instruction corresponding to the input menu control instruction, so that a user can sequentially set a menu control instruction without the need of learning difficult syntax of programs, and also can set the programmable automatic triggering system in a simple and easy manner, so as to enhance the manufacturer's acceptance significantly.

(2) The program instruction display module 12 is provided for displaying a menu control instruction that is set by the menu display module 11 and a human-like logic is adopted for displaying the menu control instruction, so that users need not to compare the difficult program codes 22 one by one to determine and confirm the accuracy of setting the menu control instructions, and thus greatly reducing human mistakes and programming, editing or setup errors.

(3) After the program code generating module 13 sends the compiled program codes 22 to the automatic triggering apparatus 2, the automatic triggering apparatus 2 can be interacted independently with the external input/output device without the need of synchronously connecting the server, such that we can save the place for installing the servers including personal computers or industrial computers when the programmable automatic triggering system and apparatus of the present invention is used. Therefore, the present invention allows a more flexible wiring layout and achieves the dual effect for a distributed processing and a central management.

(4) If the preinstalled external input/output device that is connected to the automatic triggering apparatus 2 satisfies certain specific conditions that are set by the menu control instructions, the automatic triggering apparatus 2 will perform an exchange of messages or a communication via mail, SNMP or active messaging, so as to maintain a good communication between automation and users.

While the invention has been described by means of specific embodiments, numerous modifications and variations could be made thereto by those skilled in the art without departing from the scope and spirit of the invention set forth in the claims.

What is claimed is:

1. A programmable automatic triggering system, comprising a programmable automatic triggering system and an automatic triggering apparatus, wherein:
said programmable automatic triggering system includes a menu display module and a program code generating module, and said menu display module includes one or more menu control instruction, and said each menu control instruction corresponds to an output menu control instruction; and said program code generating module compiles a menu control instruction that is set by a user, and converts said menu control instruction into a machine readable program code; and
said automatic triggering apparatus includes a real-time processor and a program code, wherein said real-time processor processes said program code that is generated by said program code generating module, and controls or instructs a preinstalled input/output equipment that is connected to said automatic triggering apparatus.

2. The programmable automatic triggering system of claim 1, wherein said programmable automatic triggering system includes a program instruction display module for displaying a menu control instruction set by a user.

3. The programmable automatic triggering system of claim 1, wherein said menu control instruction sets its mode by using ON or OFF of a power supply of said preinstalled input/output device as a control condition.

4. The programmable automatic triggering system of claim 1, wherein said menu control instruction sets its mode by using a value of a counter or a timer of said preinstalled input/output device as a control condition.

5. The programmable automatic triggering system of claim 1, wherein said automatic triggering apparatus and said preinstalled input/output device have corresponding operations for ON, OFF or Pause of a power supply.

6. The programmable automatic triggering system of claim 1, wherein said automatic triggering apparatus and said preinstalled input/output device have corresponding operations for exchanging information and communicating with a remote device through Mail, SNMP or Active Messaging.

7. The programmable automatic triggering system of claim 1, wherein said automatic triggering apparatus can interact with a preinstalled external input/output device independently, after said program code is received.

8. The programmable automatic triggering system of claim 1, wherein said programmable automatic triggering system is applicable for a device with computing and storing functions, a desktop computer, a portable computer, an industrial computer, a server or a personal digital assistant.

9. A programmable automatic triggering system, which includes a programmable automatic trigger apparatus operated with a setup procedure comprising the steps of:
(a) entering into a menu display module by a user;
(b) setting a menu control instruction, and selecting or setting up a corresponding output menu control instruction;
(c) converting a selected menu control instruction into a human-like logic and inputting said human-like logic to a program instruction display module by said programmable automatic triggering system;
(d) compiling a menu control instruction that is set by the user into a machine readable program code by a program code generating module;
(e) sending a program code compiled by said program code generating module to said automatic triggering apparatus;
(f) processing said program code by a real-time processor of said automatic triggering apparatus; and
(g) monitoring and controlling a preinstalled input/output device by said automatic triggering apparatus.
